(19) United States
(12) Patent Application Publication
(10) Pub. No.: US 2015/0207216 A1
(43) Pub. Date: Jul. 23, 2015

(54) WIRELESS MODULE

(71) Applicant: Panasonic Intellectual Property Management Co., Ltd., Osaka (JP)

(72) Inventors: Suguru Fujita, Tokyo (JP); Ryosuke Shiozaki, Tokyo (JP); Kentaro Watanabe, Hyogo (JP)

(73) Assignee: Panasonic Intellectual Property Management Co., Ltd., Osaka (JP)

(21) Appl. No.: 14/420,247

(22) PCT Filed: May 23, 2014
(86) PCT No.: PCT/JP2014/002716

§ 371 Date: Feb. 6, 2015

(30) Foreign Application Priority Data
Jun. 4, 2013 (JP) 2013-117975

(51) Int. Cl. H01Q 1/40

(52) U.S. Cl. CPC H01Q 1/40

(57) ABSTRACT

A wireless module capable of preventing deterioration of the antenna characteristics is provided. The wireless module includes a substrate including a first substrate, an antenna unit disposed on one end side of the substrate, a conductive member disposed on the other end side of one of two surfaces of the first substrate, and a molding section that covers the one of the two surfaces of the first substrate.

### TECHNICAL FIELD

The present disclosure relates to a wireless module.

### BACKGROUND ART

Electronic component modules that serve as antenna integrated wireless modules have been developed. The electronic component modules have an antenna formed in a module substrate and an LSI (Large Scale Integration) mounted in a cavity of the module substrate (refer to PTL 1).

### CITATION LIST

### Patent Literature

PTL 1: Japanese Unexamined Patent Application Publication No. 2004-342948

### SUMMARY OF INVENTION

An electronic component module described in PTL 1 sometimes have deteriorated antenna characteristics.

To address the above-described issue, the present disclosure provides a wireless module capable of preventing the deterioration of antenna characteristics.

According to an aspect of the present disclosure, a wireless module includes a substrate including a first substrate, an antenna unit disposed on one end side of the substrate, a conductive member disposed on the other end side of one of two surfaces of the first substrate, and a molding section that covers the one of the two surfaces of the first substrate. Note that these general and specific aspects may be implemented using a system, a method, an integrated circuit, a computer program, or any combination of a system, an apparatus, a method, and an integrated circuit.

According to the present disclosure, deterioration of antenna characteristics can be prevented.

### BRIEF DESCRIPTION OF DRAWINGS

FIG. 1(A) is a plan view of an example of the structure of a wireless module according to a first embodiment; and FIG. 1(B) is a cross-sectional view taken along a line A-A of FIG. 1(A).

FIG. 2 is a cross-sectional view of an example of the structure of a wireless module according to a modification of the first embodiment.

FIG. 3(A) is a plan view of an example of the structure of a wireless module according to a second embodiment; and FIG. 3(B) is a cross-sectional view taken along a line B-B of FIG. 3(A).

### DESCRIPTION OF EMBODIMENTS

Embodiments of the disclosure are described below with reference to the accompanying drawings.

### (Underlying Knowledge Forming Basis of Embodiment According to Disclosure)

In an electronic component module described in PTL 1, the outer periphery of a module substrate needs to be uniformly surrounded by a frame in order to keep a balance of stress in the module. Accordingly, among radiation patterns of the antenna, the radiation pattern in a direction along the surface of the substrate varies from module to module due to a variation of the working accuracy of the frame. Thus, the antenna characteristics may deteriorate.

A wireless module capable of preventing deterioration of antenna characteristics is described below.

A wireless module according to an embodiment described below is applied to, for example, an antenna integrated wireless module that radiates microwaves including millimeter waves.

### First Embodiment

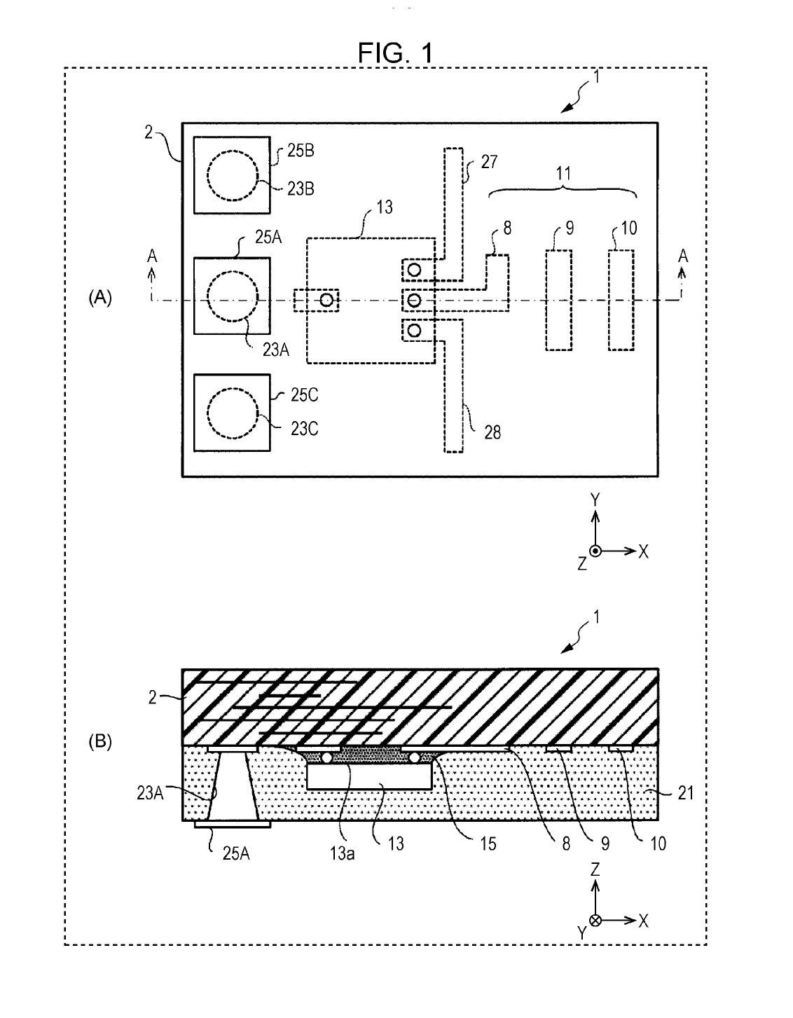

FIG. 1(A) is a plan view illustrating an example of the structure of a wireless module 1 according to a first embodiment. FIG. 1(A) is a view of a module substrate 2 of the wireless module 1 from above (from a positive side of a Z-axis). FIG. 1(B) is a cross-sectional view of the wireless module 1 taken along a line A-A of FIG. 1(A).

Let an X-Y plane be a plane parallel to the module substrate 2. In FIG. 1(A), an X direction is defined as the lateral direction, and a Y direction is defined as the longitudinal direction. In addition, a Z direction is defined as a direction that is perpendicular to the plane of the module substrate 2, that is, a direction that is perpendicular to the X-Y plane.

The wireless module 1 includes a module substrate 2 (an example of a first substrate). The module substrate 2 is, for example, a multilayer substrate. One of two surfaces of the module substrate 2 (an LSI mounting surface) has an antenna unit 11 and an LSI 13 mounted thereon. For example, the LSI 13 is flip-flop mounted. The LSI 13 includes a signal processing circuit for processing a microwave signal.

In addition, an UnderFill (UF) 15 is injected into between the LSI 13 and the LSI mounting surface of the module substrate 2. Furthermore, a molding section 21 filled with, for example, resin is formed on the LSI mounting surface of the module substrate 2 so as to cover one of the surfaces of the module substrate 2 including the LSI 13 and the antenna unit 11.

The molding section 21 has a plurality of vias 23A to 23C formed therein so that the vias 23A to 23C penetrate the molding section 21 in the Z direction. The vias 23A, 23B, and 23C are through-holes having conductivity. The vias 23A, 23B, and 23C connect the LSI mounting surface of the module substrate 2 to electrodes 25A, 25B, and 25C formed on a surface of the molding section 21 remote from the LSI mounting surface.

The plurality of vias 23A to 23C (examples of the conductive members) are disposed in the module substrate 2 on the other end side of the LSI mounting surface (on the left side (on the negative side of the X-axis) in FIGS. 1(A) and 1(B)). For example, the vias 23A to 23C are arranged at least along one side of the module substrate 2. In FIGS. 1(A) and 1(B), three vias 23A, 23B, and 23C are arranged along the left end side of the module substrate 2 extending in the Y direction. In FIG. 1(A), the via 23A located in the middle is, for example, a signal via. The vias 23B and 23C located on both sides of the via 23A are ground vias.

The antenna unit 11 is, for example, a Yagi Antenna including a radiating element 8, director elements 9 and 10, and grounds (GNDs) 27 and 28. The antenna unit 11 is disposed on the module substrate 2 on one end side thereof (on the right side (the positive X-axis side) in FIGS. 1(A) and 1(B)). The grounds 27 and 28 function as reflectors. The directivity of a Yagi Antenna significantly varies with, for example, the shape of a dielectric body present in the radiation direction or the positions of the vias.

For example, in FIGS. 1(A) and 1(B), the director elements 9 and 10 are disposed on the module substrate 2 on the one end side. In addition, the plurality of vias 23A to 23C and the electrodes 25A to 25C are disposed on the module substrate 2 on the other end side. Furthermore, the entire LSI mounting surface of the module substrate 2 is uniformly covered by the molding section 21. Accordingly, a component having a dielectric constant that varies is not disposed in the vicinity of the director elements 9 and 10 where the electric field concentrates. As a result, distortion of the radiation pattern caused by a variation of the dielectric constant can be prevented.

Assembly of the wireless module 1 is described next.

The LSI 13 is mounted (e.g., flip-flop mounted) on the module substrate 2 having wiring lines formed thereon first. The wiring lines are needed for the LSI 13 and the antenna unit 11. In this case, to improve the connection strength of the LSI 13 and prevent a foreign substance from entering a circuit surface 13a of the LSI 13, a resin material called an UnderFill 15 described above is injected.

Subsequently, at least part of the LSI mounting surface of the module substrate 2 is covered by, for example, a resin. Thus, the molding section 21 is formed. Thereafter, to lead out the electrodes on the module substrate 2 to the outside of the wireless module 1, the vias 23A to 23C are formed in the molding section 21. In addition, the electrodes 25A, 25B, and 25C, which correspond to the vias 23A, 23B, and 23C, respectively, are formed on the surface of the molding section 21. The electrodes 25A to 25C serve as electrodes used when the wireless module 1 is mounted on, for example, a set substrate (not illustrated).

Note that in FIGS. 1(A) and 1(B), only the LSI 13 and the antenna unit 11 are mounted. However, another electronic component may be mounted in addition to the LSI 13 and the antenna unit 11. For example, a chip component (e.g., an LCR element) or a surface mount technology (SMT) component (e.g., a crystal oscillator) may be mounted. In addition, by allowing part of the molding section 21 to enter between the LSI 13 and the module substrate 2, the LSI 13 may be mounted on the module substrate 2 without using the UnderFill 15.

According to the wireless module 1, the entire LSI mounting surface of the module substrate 2 is uniformly covered by the molding section 21. Accordingly, distortion of the radiation pattern caused by a variation of the dielectric constant does not occur in the portions of the antenna unit 11 having the director elements 9 and 10. As a result, deterioration of the antenna characteristics can be prevented.

In addition, electronic components (e.g., the vias 23A to 23C) are disposed on the module substrate 2 on the other end side (on the left side (the negative X-axis side) in FIG. 1(A)) so that the strength can be maintained by the molding section 21. Accordingly, even when a dummy ball is not disposed on the module substrate 2 on the one end side (the right side (the positive X-axis side) in FIG. 1(A)), the strength can be maintained. That is, there is no need for taking into account the stress balance on one side and the other side of the module substrate 2. In this manner, a space can be provided in the radiation direction of the antenna unit 11 (on the right side (the positive X-axis side) in FIG. 1(A)) and, thus, the antenna characteristics are not affected by the electronic component. As a result, the antenna characteristics is improved.

In addition, unlike existing modules, the wireless module 1 does not have, on the LSI mounting surface, a connection terminal (e.g., the electrodes 25A to 25C) connected to a set substrate. Accordingly, the space equal to the area of the connection terminal is available. Thus the antenna unit 11 can be easily disposed. Furthermore, since the LSI 13 disposed on the LSI mounting surface is covered by the molding section 21, the stress balance can be maintained and, thus, the strength of the wireless module 1 can be ensured without using a frame of the module substrate 2.

In addition, since the wireless module 1 does not have a cavity or a frame, a variation of the dielectric constant caused by a frame (e.g., a metal frame), working of a frame, positional shift of the mounting position, or a change in shape of a frame do not occur. Accordingly, for example, a variation of the directivity occurring from the antenna unit 11 to the antenna unit 11 caused by uneven thicknesses of the wireless module 1 during working can be prevented. As a result, deterioration of the antenna characteristics can be prevented.

### (Modifications)

The wireless module 1 has the antenna unit 11 mounted so as to be flush with the LSI mounting surface of the module substrate 2. However, the antenna unit may be mounted on the surface of the module substrate 2 opposite to the LSI mounting surface.

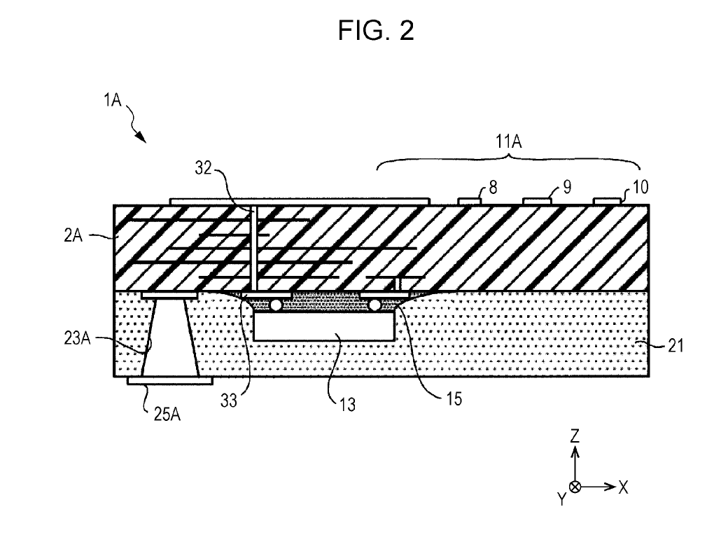

FIG. 2 is a cross-sectional view of an example of the structure of a wireless module 1A according to a modification of the first embodiment. The cross-sectional view corresponds to FIG. 1(B). Components of the wireless module 1A that are the same as those of the wireless module 1 illustrated in FIGS. 1(A) and 1(B) are given the same reference numerals as those used in FIGS. 1(A) and 1(B), and the descriptions thereof are not repeated or simplified.

In the wireless module 1A, the antenna unit 11A is mounted on a surface of a module substrate 2A opposite to an LSI mounting surface, that is, the other surface of the module substrate 2A on one end side thereof (on the right side (on the positive X-axis side) in FIG. 2). In addition, a via 32 that connects an electrode pad 33 of the LSI 13 to an antenna unit 11A is formed in the module substrate 2A.

Like the wireless module 1, according to even the wireless module 1A of the modification, the stress balance can be maintained by the molding section 21 and, thus, the need for a frame can be eliminated. As a result, deterioration of the antenna characteristics can be prevented. In addition, the antenna unit 11A can be disposed on the outer surface of the module substrate 2A (one of two surfaces that does not face the molding section 21). Furthermore, since the antenna unit 11 is not covered by the molding section 21, the antenna characteristics can be improved more.

### Second Embodiment

According to the first embodiment, the antenna unit is disposed on the module substrate. In contrast, according to a second embodiment, an antenna substrate having an antenna unit mounted thereon is provided so as to face a molding section on the module substrate.

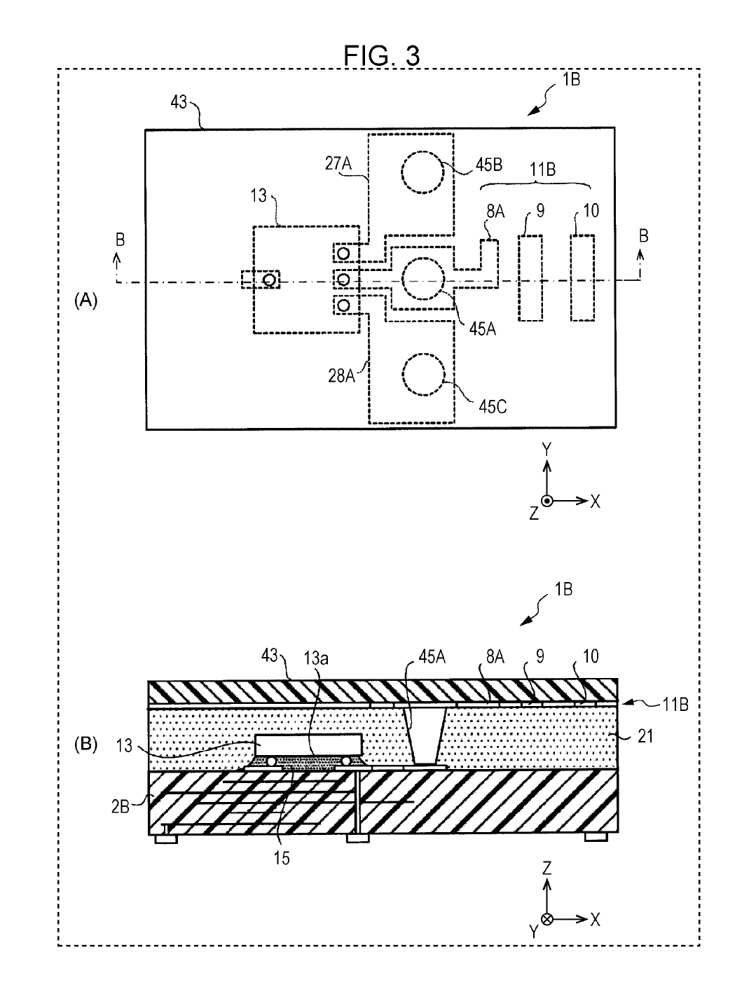

FIG. 3(A) is a plan view of an example of the structure of a wireless module 1B according to the second embodiment. FIG. 3(A) is a view of an antenna substrate 43 of the wireless module 1B from above (in a normal Z-axis direction). FIG. 3(B) is a cross-sectional view of the wireless module 1B taken along a line B-B of FIG. 3(A). Components of the wireless module 1B that are the same as those of the first embodiment are given the same reference numerals as those of the first embodiment, and the descriptions thereof are not repeated or simplified.

Like the wireless module 1A, in the wireless module 1B, the LSI 13 is mounted on the LSI mounting surface of a module substrate 3B. The UnderFill 15 is injected onto the circuit surface 13a of the LSI 13, and the LSI mounting surface is covered by the molding section 21.

In addition, in the wireless module 1B, an antenna substrate 43 (an example of a second substrate) having the antenna unit 11B mounted thereon is disposed on top of the molding section 21 (on a positive Z-axis side) so as to face a module substrate 2B. The antenna unit 11B is a Yagi Antenna including a radiating element 8A, director elements 9 and 10, and grounds (GNDs) 27A and 28A. The antenna unit 11B is disposed on one of the surfaces of the antenna substrate 43 that faces the molding section 21 (a surface facing to the molding section) on one end side thereof (on the right side (a positive X-axis side) in FIGS. 3(A) and 3(B)).

The molding section 21 has a signal via 45A formed therein. The via 45A connects the radiating element 8A to an electronic component (e.g., the LSI 13) mounted on the LSI mounting surface of the module substrate 2B. In addition, although not illustrated in FIG. 3(B), the molding section 21 has vias 45B and 45C for GND formed therein. The vias 45B and 45C connect, to the LSI mounting surface of the module substrate 2B, grounds 27A and 28A disposed on both sides of the radiating element 8A in the Y direction.

Like the first embodiment, according to the wireless module 1B, deterioration of the antenna characteristics can be prevented. In addition, by mounting the antenna unit 11B on the antenna substrate 43, the accuracy of assembly of the antenna unit 11B can be increased.

In addition, by forming the antenna unit 11B on the surface (facing to the molding section) of the antenna substrate 43, the antenna substrate 43 need not have a via that penetrates the antenna substrate 43.

Note that to mount the antenna substrate 43 on the molding section 21, one of eutectic bonding using solder disposed between an electrode on the antenna substrate 43 and an electrode on the molding section 21, bonding using a conductive material, and thermocompression bonding using a resin sheet is employed.

### (Modifications)

The wireless module 1B has the antenna unit 11B mounted on the surface (facing to the molding section) of the antenna substrate 43. However, the antenna unit may be mounted on a surface that faces the surface facing to the molding section (the opposite surface). In such a case, although not illustrated, a via that connects a radiating element of the antenna unit mounted on the opposite side of the surface facing to the molding section to the signal via 45A mounted on the surface facing to the molding section is formed in the antenna substrate 43. In addition, in such a case, like the wireless module 1, the wireless module 1A, and the wireless module 1B, the antenna unit is disposed on one end side, and the other electronic components (e.g., a via and an electrode) are disposed on the other end side.

According to the modification, like the wireless module 1B, the stress balance is maintained by the molding section 21 and, thus, the need for a frame can be eliminated. As a result, deterioration of the antenna characteristics can be prevented. In addition, since the antenna unit 11A is mounted on the outer surface of the module substrate 2A (the surface opposite to the surface facing to the molding section), the antenna unit 11 is not covered by the molding section 21. Accordingly, the antenna characteristics can be improved more. Furthermore, like the wireless module 1B, by mounting the antenna unit on the antenna substrate 43 instead of the molding section 21, the accuracy of assembly of the antenna unit can be increased.

It should be noted that the structure is not limited to that of the above-described embodiment. Any structure that provides the function of the structure described in the claims or the structure of the present embodiment is applicable.

For example, while the above embodiment has been described with reference to a module substrate formed as a multilayer substrate, a single-layer substrate may be employed. In addition, while the above embodiment has been described with reference to an antenna unit using a Yagi Antenna, an antenna other than a Yagi Antenna may be employed.

While the above-described description has been made with reference to the structure without using a wiring line connected to a dielectric body above and below the antenna, a wiring line may be provided to at least part of the inner layer or a surface layer of the dielectric body, and the dielectric body may cover the antenna. The wiring line may be disposed above and below the antenna. Alternatively, the wiring line may be disposed only above or below the antenna. In addition, the wiring line may be connected to GND. In this manner, when the wireless module is mounted on a set substrate, a variation of the characteristics caused by the wiring line and the dielectric body can be prevented.

### Summary of Embodiment of Present Disclosure

A first wireless module of the present disclosure includes a substrate including a first substrate, an antenna unit disposed on one end side of the substrate, a conductive member disposed on the other end side of one of two surfaces of the first substrate, and a molding section that covers the one of the two surfaces of the first substrate.

A second wireless module of the present disclosure is the first wireless module in which the antenna unit is disposed on the one end side of the one of the two surfaces of the first substrate on the one end side.

A third wireless module of the present disclosure is the first wireless module in which the antenna unit is disposed on the one end side of the other surface of the two surfaces of the first substrate.

A fourth wireless module of the present disclosure is the first wireless module in which the substrate includes a second substrate, the second substrate being disposed so as to face the first substrate with the molding section therebetween, and the antenna unit is disposed on the one end side of one of the two surfaces of the second substrate, the one of the two surfaces of the second substrate facing the molding section.

A fifth wireless module of the present disclosure is the first wireless module in which the substrate includes a second substrate, the second substrate being disposed so as to face the first substrate with the molding section therebetween, and the antenna unit is disposed on the one end side of the other surface of two surfaces of the second substrate, the other surface of the second substrate being opposite to one of the two surfaces that faces the molding section

### INDUSTRIAL APPLICABILITY

The present disclosure is effective for, for example, a wireless module capable of preventing deterioration of the antenna characteristics.

### REFERENCE SIGNS LIST

1, 1A, 1B wireless module
2, 2A, 2B module substrate
8, 8A radiating element
9, 10 director element
11, 11A, 11B antenna unit
13 LSI
15 UnderFill
21 molding section
23A, 23B, 23C, 32, 45A, 45B, 45C via
25A, 25B, 25C electrode
27, 27A, 28, 28A ground (GND)
33 electrode pad
43 antenna substrate

1. A wireless module comprising:
a substrate including a first substrate;
an antenna unit disposed on one end side of the substrate;
a conductive member disposed on the other end side of one of two surfaces of the first substrate; and
a molding section that covers the one of the two surfaces of the first substrate.

2. The wireless module according to claim 1, wherein the antenna unit is disposed on the one end side of the one of the two surfaces of the first substrate.

3. The wireless module according to claim 1, wherein the antenna unit is disposed on the one end side of the other surface of the two surfaces of the first substrate.

4. The wireless module according to claim 1, wherein the substrate includes a second substrate, the second substrate being disposed so as to face the first substrate with the molding section therebetween, and
wherein the antenna unit is disposed on the one end side of one of the two surfaces of the second substrate, the one of the two surfaces of the second substrate facing the molding section.

5. The wireless module according to claim 1, wherein the substrate includes a second substrate, the second substrate being disposed so as to face the first substrate with the molding section therebetween, and
wherein the antenna unit is disposed on the one end side of the other surface of two surfaces of the second substrate, the other surface of the second substrate being opposite to one of the two surfaces that faces the molding section.
